(19) United States
(12) Patent Application Publication
(10) Pub. No.: US 2014/0322386 A1
(43) Pub. Date: Oct. 30, 2014

(54) BEER BREWING ADDITIVE AND METHOD

(71) Applicant: NORTHERN BREWER LLC, Roseville, MN (US)

(72) Inventors: James C. Farley, St. Paul, MN (US); Vaughn K. Stewart, St. Paul, MN (US); Deborah A Loch, St. Paul, MN (US)

(21) Appl. No.: 13/869,649

(22) Filed: Apr. 24, 2013

(51) Int. Cl. C12C 12/00

(52) U.S. Cl. CPC C12C 12/00
USPC 426/8; 426/62

(57) ABSTRACT

A method and additive for making beer includes the use of an additive tablet of yeast and sugar, as well as other additives, that is inserted into bottles of beer prior to capping. After the bottles are capped, these additive tablets promote secondary fermentation and carbonation of the beer within the bottles to form carbon dioxide and ethyl alcohol.

### FIELD OF THE INVENTION

The present invention relates generally to a beer brewing additive and method of brewing beer and more specifically to the use of an additive in the form of a tablet, pellet, drop, powder or the like to instigate a fermentation process in a beer bottle to create carbonation.

### BACKGROUND

Nearly all beer will have four basic ingredients: malt, hops, yeast and water. Beer is brewed by fermenting the sugars of malted barley and other cereal grains. Malting stimulates amylase enzyme production within the grain. Brewers crush the malted grain and soak it in hot water in a process known as “mashing.” This activates the enzymes, which convert the grain's starch into sugars. These sugars are then rinsed from the grain and the resulting liquid, known as “wort”, is boiled with hops and other ingredients.

Hops are the cone-shaped flower of the perennial Humulus lupulus plant. Hops are added to wort to impart a bitterness perfect to balance the sweetness of malt and to provide a wide variety of flavors and aromas. In addition to the bittering, flavoring and aromatic qualities that hops bring to beer, they also serve as a stability agent, preventing spoilage, contribute to head retention and act as a natural clarifier. After boiling with hops, the wort is cooled. During primary fermentation, yeast cells are added to the cooled wort. The yeast cells consume the sugar in the wort through the fermentation process and carbon dioxide and alcohol are produced as waste products.

It is common for the beer making process to include a primary fermentation step in which beer is produced from the wort through the fermentation activities of the yeast. The yeast converts the fermentable sugar in the wort into alcohol and carbon dioxide. During the primary fermentation process a layer of krausen, a foamy head of yeast and other particles, forms on top of the beer. The krausen normally dissipates over time and any remaining grain particles, hop particles and dead yeast cells will settle to the bottom of the fermenter kettle in a mass known as “trub”. The trub is separated from the wort or the wort is transferred to a bucket, carboy or fermentation vessel.

Once primary fermentation is complete, a secondary fermentation step may be undertaken to carbonate the beer. The secondary fermentation process is initiated by adding sugar to the vessel. Any yeast remaining in the beer will then consume the added sugar to further carbonate the beer. The beer is transferred to personal consumption containers such as bottles or cans for capping or any other form of sealing, storage and eventual consumption.

When secondary beer fermentation occurs within the beer bottle, it is referred to as “bottle conditioning”. This bottle conditioning is instigated by adding sugar to a non-carbonated beer and then allowing the added sugar to react with the remaining yeast that is in suspension in the beer to create beer carbonation in the closed container. Alternatively, a given amount of sugar and yeast can be added to a large volume of un-carbonated beer in a bottling bucket, carboy or alternate vessel and then poured or siphoned into the bottles which are capped to allow bottle conditioning to occur.

Available on the market today for bottle conditioning of beer for home brewing kits are carbonation tabs which are basically sugar cubes without any reactionary agent that are dropped into individual bottles of non-carbonated beer, capped and left to carbonate with the suspended yeast in the bottles. Two such products are: Brewer's Best Conditioning Tabs available from www.northernbrewer.com and Cooper's Carbonation Drops. Scott Laboratories has also developed a pellet for use in home wine making that consists of yeast and alginate, but the pellet does not include the yeast necessary for beer carbonation.

U.S. Pat. No. 4,911,936 issued on Mar. 27, 1990 to Kijima et al. discloses a method of trying to maintain the freshness and flavor of a beer over a period of time by adding a small amount of yeast with a product beer which has been substantially fermented, therein significantly preventing the change of its flavor with the passage of time. No additional sugar is added to the product beer.

US patent publication number 2002/0136816 A1 to Kim published on Sep. 2, 2002 discloses a dry composition capable of generating alcoholic beer in the presence of water. The composition includes agglomerates of an edible carbonation source and a powdered source of alcoholic beer. The edible carbonation source includes a water soluble carbonate and an acid. The source of alcoholic beer is a spray dried solution of beer and a water soluble material such as gelatin or a modified starch. The composition may be used as a free flowing powder or the powder may be compressed into tablet form.

There is always a desire to streamline, simplify and speed up the beer making process without compromising the quality and taste of the beer, particularly in the home brewing market. Moreover, changes and improvements in the beer making process can save money as well as time.

### BRIEF SUMMARY OF EMBODIMENTS

A method and additive for making beer includes the use of an additive tablet of yeast and sugar, as well as other additives, that is inserted into bottles of beer prior to capping. After the bottles are capped, these additive tablets promote secondary fermentation and carbonation of the beer within the bottles to form carbon dioxide and ethyl alcohol.

A preferred method for brewing beer includes the steps of: making wort by soaking grains in water to release malt sugars, boiling the water together with the hops and cooling the wort after boiling; fermenting the cooled wort for a predetermined period of time in a primary fermentation process by adding yeast to the wort; transferring the fermented wort to bottles, adding a mixture of yeast and sugar to the wort in each bottle to instigate a secondary fermentation process and carbonation, and finally capping the bottles.

The above and other aspects of various embodiments of the present invention will become apparent in view of the following description, claims and drawing.

### BRIEF DESCRIPTION OF THE DRAWING

FIG. 1 is a flow chart diagram of a method for making beer in accordance with the principles of the invention.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

Conventional beer making methods, especially for the home brewing market, require the purchase of specific beer making equipment and supplies which can include: a kettle with a cover and an adjacent burner kit; fermenter and bottling bucket, carboy or other container; cleaners, sanitizers, brushes and other cleaning equipment; tubing for siphoning and bottling; beer bottles, caps and a bottle capper; malted barley or extracts or other cereal grains; hops, yeast and other accessories and ingredients dependent on the specific beer recipe.

An improved process according to the invention eliminates the need for the secondary bottling bucket or carboy so that the beer is directly siphoned into bottles for personal consumption and an additive (hereinafter referred to as a “tablet” for simplicity) in the form of a tablet, capsule, caplet, pellet, pill, drop, powder, solid composition, liquid composition or the like is inserted into each bottle to provide bottle conditioning that leads to beer carbonation. Before, during, or after the beer is transferred to the bottles, the tablet can be added to each bottle of beer. The tablet in it's most basic form will include (1) beer making yeast such as Saccharomyces cerevisiae, Saccharomyces pastorianus or any similar variety or species which is useful for beer fermentation, and (2) sugar in any form. Other yeasts such as Brettanomyceses, Schizosaccharomyces pombe, Saccharomyces bayanus or for instance, any of the many yeasts commonly used in wine making, can also be used.

The yeast to sugar ratio of the additive/tablet may vary with one preferred embodiment having about 0.5 grams of yeast to 4.0 grams of sugar. A second embodiment provides each tablet having about 0.018 grams of yeast to 2 grams of sugar. However, any ratio of yeast to sugar is possible so long as fermentation is the result of mixing the tablet with the beer in the bottle. The fermentation rate as well as the total amount of fermentation can be controlled by the amount and ratio of sugar and yeast in each tablet. The fermentation occurs when the yeast consumes the sugar and produces carbon dioxide and alcohol.

The optimal mixture and proportions of ingredients for one preferred embodiment of the tablet are itemized in TABLE I below. However the proportions of TABLE I will change based upon the specific yeast and sugar used.

TABLE I

| SUPPLEMENT FACTS | | |
|---|---|---|
| Amounts per tablet | 1 tab | |
| DIPAC tablet grade sugar | 1961.91 | mg |
| Active dried yeast Saccharomyces uvarum | 18 | mg |
| Stearic acid veg grade | trace | |
| Magnesium stearate veg grade | trace | |
| Croscarmellose sodium NF, Ph. Eur., JP | trace | |

The use of vegan or vegetarian components in the tablet, such as the stearic acid veg grade and magnesium stearate veg grade in TABLE I above, is an option which is valuable in marketing and awareness to the public since many consumers prefer to purchase products which do not include meat or animal products and which are considered vegan or vegetarian for their own moral, religious or health reasons.

With traditional secondary bottle fermentation, yeast cells are in suspension in a non-filtered beer and the yeast stays in the beer for quite a while until sugar is added to the bottle or other storage vessel being used. Upon closure of the bottle/vessel, the yeast and added sugar chemically react to create carbon dioxide, i.e. carbonation, and alcohol.

The combination of both yeast and sugar as additives in the inventive tablet creates a much quicker, more active and longer lasting secondary fermentation than is possible by the singular addition of either yeast or sugar to a bottle of beer. Moreover the use of the tablet allows for simple, repeatable, consistent carbonation from bottle to bottle. There is no need to transfer the beer to another container to add sugar and yeast before transferring the mixture to the bottles. Also the use of the tablet allows simple, consistent, repeatable addition of other desirable ingredients that can be included within the tablet, such as heading agents.

The tablet can be manufactured to include additional components such as (1) propylene glycol alginate or any other heading agent for generating a head on the beer, (2) a filler or binder such as Biofoam K or a similar Xanthan gum, and (3) a lubricant (binding agent) such as Silica. The shell or outer surface of the tablet can be made out of sugar, gelatin, starch or cellulose. Table II below lists a variety of additives that can be added to the tablet, and the purpose of each additive.

TABLE II

| ADDITIVE TO A TABLET | PURPOSE OF THE ADDITIVE |
|---|---|
| Flavors | To add various flavors |
| Hop extracts | To add bitterness |
| Various Sugars (such as honey, | To change the flavor of the sugar |
| molasses, maple syrup, etc) | |
| Various Starches | To increase binding and handling |
| Coloring | To adjust the color |
| Non fermentable sugars such as | To add sweetness |
| lactose or maltodextrin | |
| Fining/clarifying agents | Added to drop yeast and haze- |
| | forming particles out of the beer |
| Stabilizers such as xhantum gum | To stabilize the pellet |
| Binders | To bind the ingredients |
| Excipients such as hypermellose or | To help manufacture the |
| similar | ingredients |
| Minerals such as Gypsum (CaSO4), | For flavor, mouth feel or |
| Calcium Chloride (CaCl), NaCl, | yeast nutrition |
| or Zn++ | |
| Acids | For Flavor |
| Bacteria such as lactic acid bacteria | For Flavor |
| Enzymes | Such as proteases to breakdown |
| | excess proteins to help clarify the |
| | beer. Alpha - acetyl lactate |
| | enzyme to eliminate diacetyl to |
| | improve flavor |

Although the dimensions of the tablet can vary, a 16 millimeter maximum diameter is anticipated so that the tablet will easily fit through a standard beer bottle neck. In a preferred embodiment, the total unit eight of the tablet is 2068 milligrams. Of course the dimensions, mass and weight can vary as long as the tablet can be inserted into the beer bottle or container, typically designed for consumer consumption. Additionally, depending on the size of bottle, type of beer, or other factors, more than one tablet can be inserted into a bottle.

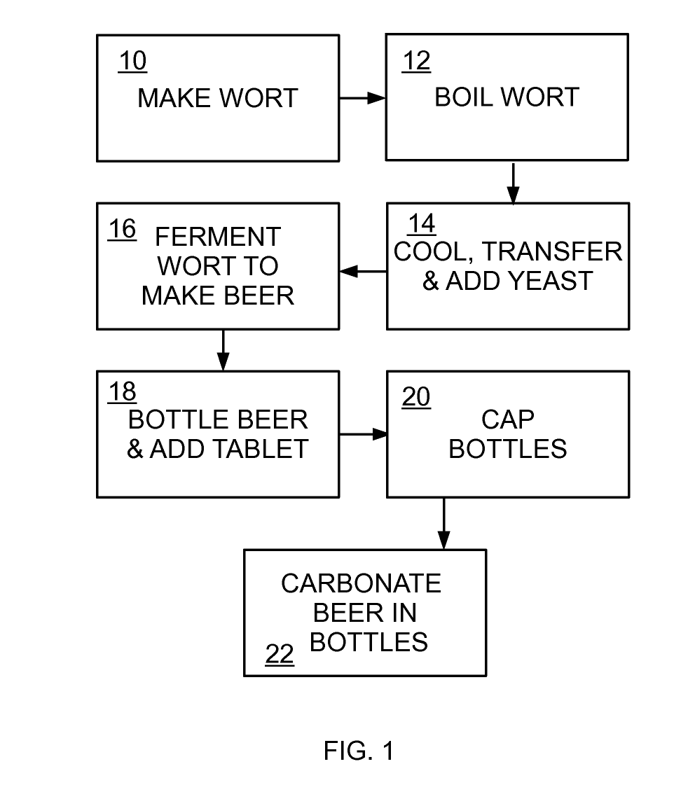

FIG. 1 illustrates the inventive method as steps in a flow diagram. First the beer wort is made in step 10. The wort is boiled and hops are added for bittering, flavor and aroma in Step 12. The wort is cooled and transferred to a fermentation vessel where yeast is added in Step 14. The wort is allowed to ferment (e.g. one to two weeks) to make beer in step 16. During this primary fermentation period the yeast is consuming the sugars within the wort resulting in carbonation, i.e. the production of carbon dioxide CO2, and ethanol alcohol C₂H₅OH.

Once fermentation is substantially complete in step 16, then one or more tablets are inserted into each bottle which is also filled with beer in step 18, allowing some air space at the top of the bottle. The number of tablets inserted into each bottle depends upon the amount of additional fermentation desired and of course the size of the tablets in terms of yeast and sugar content and ratio. The number of tablets is also dependent upon the volume of the beer bottles. The bottles are capped in step 20 and the secondary bottle fermentation and carbonation of the beer is instigated in step 22 by the addition of the yeast and sugar tablet with the beer in the capped bottle. Of course, the size of the tablets and the amount and ratios of yeast and sugar in each tablet and in each bottle is carefully determined beforehand to provide optimal secondary fermentation for a tasty carbonated beer.

While the invention has been shown and described with reference to specific embodiments, it should be understood by those skilled in the art that various changes in form and detail may be made therein without departing from the spirit and scope of the invention.

What is claimed is:

1. An additive for use in beer making, comprising a yeast and sugar mixture added to wort in bottles to be capped to instigate a bottled fermentation and carbonation process by producing carbon dioxide to carbonate a beer and to produce ethanol alcohol within the capped bottles.

2. The additive of claim 1 wherein the yeast and sugar mixture is in a form selected from a group consisting of a tablet, a capsule, a caplet, a pellet, a pill, a drop, a powder, a solid composition and a liquid composition.

3. The additive of claim 1 wherein the yeast comprises one of Saccharomyces cerevisiae, Saccharomyces pastorianus, Saccharomyces uvarum, Saccharomyces bayanus, Schizosaccharomyces pombe or Brettanomyceses.

4. The additive of claim 1 wherein said yeast and sugar mixture comprises 0.5 grams of yeast and 4.0 grams of sugar.

5. The additive of claim 1 wherein said yeast and sugar mixture comprises 0.018 grams of yeast and 2.0 grams of sugar.

6. The additive of claim 1 wherein said yeast and sugar mixture further comprises a heading agent.

7. The additive of claim 1 wherein said yeast and sugar mixture further comprises a clarifying agent to drop yeast and haze forming particles out of the beer.

8. The additive of claim 1 wherein said yeast and sugar mixture further comprises enzymes to break down excess proteins and clarify the beer.

9. The additive of claim 1 wherein said yeast and sugar mixture further comprises a mineral from the group consisting of gypsum (CaSO4), calcium chloride (CaCl), sodium chloride (NaCl) and Zn++.

10. The additive of claim 1 wherein said yeast and sugar mixture further comprises stearic acid veg grade, magnesium stearate veg grade and croscarmellose sodium.

11. The additive of claim 1 wherein said yeast and sugar mixture further comprises non-fermentable sugars including as lactose or maltodextrin.

12. The additive of claim 1 wherein said yeast and sugar mixture further comprises a hypermellose excipient.

13. The additive of claim 1 wherein said yeast and sugar mixture further comprises lactic acid bacteria, hop extracts and flavoring.

14. The additive of claim 1 wherein said yeast and sugar mixture further comprises an xhantum gum stabilizer.

15. A method for brewing beer comprising the steps of:
making wort by soaking grains in water to release malt sugars, boiling the water together with the grains and hops and cooling the wort after boiling;
fermenting the cooled wort for a predetermined period of time in a primary fermentation process by adding yeast to the wort;
transferring the fermented wort to bottles, adding a mixture of yeast and sugar to the wort in each bottle to instigate a secondary fermentation process and carbonation, then capping the bottles.

16. The method of claim 15 wherein the added mixture is in a form selected from a group consisting of a tablet, a capsule, a caplet, a pellet, a pill, a drop, a powder, a solid composition and a liquid composition.

17. The method of claim 15 wherein the added mixture further comprises stearic acid veg grade, magnesium stearate veg grade and croscarmellose sodium.

18. The method of claim 15 wherein the added mixture comprises 18 milligrams of yeast and 1961.91 milligrams of sugar.

19. A method for brewing beer comprising the steps of:
making wort by soaking grains in water to release malt sugars, boiling the water together with the grains and hops and cooling the wort after boiling;
fermenting the cooled wort for a predetermined period of time in a primary fermentation process by adding yeast to the wort to make beer;
transferring the beer to containers to be used for consumer consumption;
adding sugar to the beer in each container;
adding yeast to the beer in each container; and
sealing the containers, wherein the addition of sugar and yeast to each sealed container instigates fermentation and carbonation.
